(19) United States
(12) Patent Application Publication
(10) Pub. No.: US 2015/0084598 A1
(43) Pub. Date: Mar. 26, 2015

(54) BATTERY SYSTEM, METHOD OF CONTROLLING BATTERY SYSTEM, AND ENERGY STORAGE SYSTEM INCLUDING THE SAME

(71) Applicant: Samsung SDI Co., Ltd., Yongin-si (KR)

(72) Inventor: Hyun-Chul Song, Yongin-si (KR)

(73) Assignee: Samsung SDI Co., Ltd., Yongin-si (KR)

(21) Appl. No.: 14/223,350

(22) Filed: Mar. 24, 2014

(30) Foreign Application Priority Data
Sep. 23, 2013 (KR) 10-2013-0112852

(51) Int. Cl. H02J 7/00

(52) U.S. Cl. CPC H02J 7/0013
USPC 320/128

(57) ABSTRACT

A battery system is disclosed. In one aspect, the battery system includes a plurality of battery trays including at least one battery cell, a plurality of slave BMSs for controlling the battery trays, and a master BMS for controlling the slave BMSs. Each slave BMS includes a switch for generating a pulse signal according to an input, a display for displaying a status of the battery tray, and a controller. The controller determines an operation mode of the slave BMS according to the pulse width of the pulse signal, sets an identifier (ID) of the slave BMS according to the number of generated pulse signals, and displays the ID of the slave BMS on the display.

### CROSS-REFERENCE TO RELATED APPLICATIONS

This application claims the benefit of Korean Patent Application No. 10-2013-0112852, filed on Sep. 23, 2013, in the Korean Intellectual Property Office, the disclosure of which is incorporated herein in its entirety by reference.

### BACKGROUND

1. Field

The described technology generally relates to a battery system for setting an identifier (ID) of a slave battery management system (BMS), a method of controlling the battery system, and an energy storage system including the same.

2. Description of the Related Technology

As problems such as environmental destruction and resource depletion have been raised, there is a growing interest in systems for storing power and efficiently using the stored power. Additionally, interest in pollution-free renewable energy is increasing. A power storage system is a system that can connect such a new renewable energy generation system, a battery for storing power, and an existing power grid. Much research and development is being conducted on power storage systems due to recent environmental changes.

The standard power storage system includes a battery system which is variously designed according to the amount of power supplied to the battery system. The battery system will receive power from a source external to the energy storage system and store the received power as well as supply the stored power to external devices. In other words, the standard battery system performs charging and discharging operations.

The standard battery system measures an internal status to aid in stable operation and gathers the measured data. The battery system typically includes various battery management units having a master-slave structure. Battery management units that correspond to slaves, hereinafter referred to as a slave battery management system (BMS), can transmit the measured data to a master BMS. Then, the master BMS receives and gathers all the measured data.

### SUMMARY OF CERTAIN INVENTIVE ASPECTS

One inventive aspect is a battery system for setting and displaying the ID of a slave BMS by using a switch for software-resetting the slave BMS and a display unit, a method of controlling the battery system, and a power storage system including the same.

Another aspect is a battery system including a plurality of battery trays including one or more battery cells, a plurality of slave BMS for controlling the battery trays, and a master BMS for controlling the slave BMSs, wherein each slave BMS includes a switch for generating a pulse signal according to an input, a display for displaying a status of the battery tray, and a controller for determining an operation mode according to a pulse width of the pulse signal, setting an identifier (ID) of the slave BMS according to the number generated pulse signals, and displaying the ID of the slave BMS on the display.

The controller may determine an input period of the input to the switch based on the pulse width of the pulse signal and enter an ID setting mode when the input period is greater than a predetermined first period.

The controller may determine the period of the input to the switch based on the pulse width of the pulse signal and enter a reset mode in which the controller is software-reset when the input period is less than the predetermined first period.

The display may include a plurality of display devices and display the ID of the slave BMS as a binary number by turning the display devices on or off.

The display may display that the slave BMS is operating in the ID setting mode.

The controller may exit the ID setting mode and enter a battery charge/discharge mode when the input period is greater than the predetermined first period.

The display may display a status of the battery tray when the slave BMS is in the charge/discharge mode, where the status includes at least one of a charge/discharge status, a voltage status, or a temperature status of the battery tray.

The master BMS and the slave BMS may communicate using a controller area network (CAN) communication.

Another aspect is a method of controlling a battery system, which includes a plurality of slave BMSs for controlling a plurality of battery trays including one or more battery cells, and a master BMS for controlling the slave BMSs, the method includes receiving a pulse signal from a switch that generates the pulse signal according to an input, determining an operation mode according to the pulse width of the pulse signal, setting an identifier (ID) of the slave BMS according to the number of generated pulse signals, and displaying the ID of the slave BMS.

The determining may include determining an input period of the input to the switch based on the pulse width of the pulse signal and entering an ID setting mode when the input period is greater than a predetermined first period.

The determining may include determining the period of the input to the switch based on the pulse width of the pulse signal and entering a reset mode in which the slave BMS is software-reset when the input period is less than the predetermined first period.

The displaying may be performed by displaying the ID of the slave BMS as a binary number by turning the display devices on or off.

The displaying may be performed by displaying that the slave BMS is operating in the ID setting mode.

The method may further include exiting the ID setting mode and entering a battery charge/discharge mode when the input period is greater than the predetermined first period.

The method may further include displaying a status of the battery tray in the battery charge/discharge mode, wherein the status includes at least one of a charge/discharge status, a voltage status, and a temperature status of the battery tray.

The master BMS and the slave BMS may communicate using a controller area network (CAN) communication.

Another aspect is a power storage system including a battery system that includes a plurality of slave BMSs for controlling a plurality battery trays including one or more battery cells, and a master BMS for controlling the slave BMSs, wherein the power storage system is connected to a power generation system, a grid, and a load, wherein the power storage system supplies power from the battery system, the power generation system, or the grid, to the load, wherein each of the slave BMS includes a switch for generating a pulse signal according to an input, a display for displaying a status of the battery tray, and a controller for determining an operation mode according to a pulse width of the pulse signal, setting an identifier (ID) of the slave BMS according to the number generated pulse signals, and displaying the ID of the slave BMS on the display.

The controller may be further configured to: i) determine an input period of the input to the switch based at least in part on the pulse width of the pulse signal and ii) start an ID setting mode when the input period is greater than a predetermined first period. The controller may be further configured to start a reset mode when the input period is less than the predetermined first period. The controller may be further configured to end the ID setting mode and start a battery charge/discharge mode when the input period is greater than the predetermined first period.

### BRIEF DESCRIPTION OF THE DRAWINGS

FIG. 1 is a block diagram of an energy storage system according to an embodiment.

FIG. 2 is a block diagram of a battery system according to an embodiment.

FIG. 3 is a block diagram of a battery rack according to an embodiment.

FIG. 4 is a block diagram of a communication system having a master-slave structure.

FIG. 5 is a diagram illustrating a frame structure of a controller area network (CAN) communication protocol.

FIG. 6 is a block diagram of the battery system having the master-slave structure for setting and displaying an identifier (ID).

FIGS. 7A through 7E are diagrams for explaining the status of the battery system of FIG. 6.

FIG. 8 is a flowchart illustrating a method of controlling the battery system having the master-slave structure for setting and displaying an ID.

### DETAILED DESCRIPTION OF CERTAIN INVENTIVE EMBODIMENTS

Generally, slave battery management systems (BMSs) each have a unique identifier (hereinafter, referred to as ID) so that the master BMS can identify the slave BMSs. The unique ID can be set to correspond to a connection order of each slave BMS, so as to be easily managed. However, an additional circuit must be provided to detect the connection order or the locations of the slave BMSs so that each one can have a unique ID corresponding to the connection order. This increases the unit cost of the battery system.

In order to assign a unique ID to the slaves corresponding to the connection order without having to further provide an additional circuit or apparatus, the hardware of the slaves needs to be configured differently or different software needs to be uploaded. In this case, the hardware and/or software needs to be independently developed and managed.

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Rather, these embodiments are provided so that this disclosure will be thorough and complete, and will fully convey the scope of embodiments to those of ordinary skilled in the art. Accordingly, the embodiments are merely described below, by referring to the figures, to explain aspects of the described technology and the scope of embodiments should be defined by the appended claims. As used herein, the term “and/or” includes any and all combinations of one or more of the associated listed items. Expressions such as “at least one of,” when preceding a list of elements, modify the entire list of elements and do not modify the individual elements of the list.

The terms used in the present specification are merely used to describe exemplary embodiments, and are not intended to limit the described technology. An expression used in the singular includes the expression of the plural, unless the context clearly indicates otherwise. In the present specification, it is to be understood that the terms such as “including” or “having,” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added. While such terms as “first,” “second,” etc., may be used to describe various components, such components must not be limited by the above terms. The above terms are used only to distinguish one component from another.

Hereinafter, embodiments of the described technology will be described in detail by explaining exemplary embodiments with reference to the attached drawings. Like reference numerals in the drawings denote like elements and thus redundant descriptions thereof will be omitted.

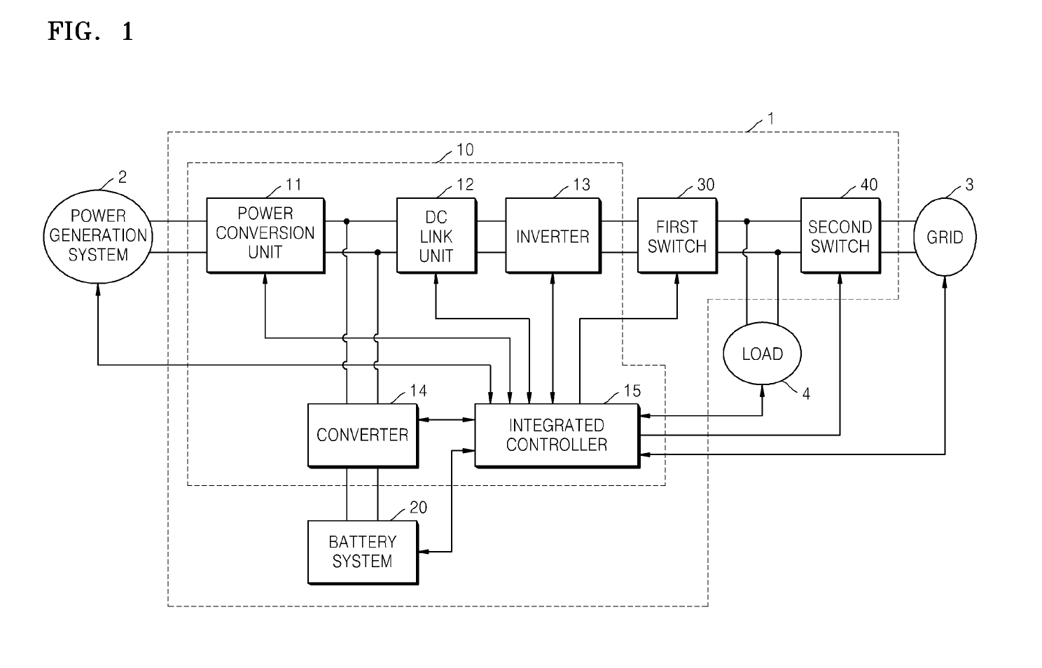

FIG. 1 is a block diagram of an energy storage system 1 according to an embodiment.

Referring to FIG. 1, the energy storage system 1 is connected to a power generation system 2 and a grid 3 so as to supply power to a load 4.

The power-generation system 2 generates power from an energy source. The power-generation system 2 may include, for example, at least one of a solar photovoltaic power generation system, a wind turbine generation system, or a tidal generation system. However, these systems are only provided as examples and the power generation system 2 is not limited thereto. For example, the power generation system 2 may include any power generation system that generates power by using new renewable energy such as solar heat or geothermal heat. For example, since a solar cell generates power by using sunlight and may be easily installed at home or in a factory, the solar cell may be used with the energy storage system 1 at home or in a factory. The power generation system 2 may be provided with a plurality of power generation modules that are arranged in parallel and/or in series with each other and generate power constituting a high-capacity energy system.

The grid 3 may include a power station, a substation, or a transmission line. When the grid 3 is in a normal state, the grid 3 may supply power to the energy storage system 1, that is, the grid may 3 supply power to at least one of the load 4 or a battery system 20. Additionally, in the normal state, the grid 3 may receive power from the energy storage system 1, particularly, the battery system 20. When the grid 3 is in an abnormal state, power transmission between the grid 3 and the energy storage system 1 is ceased.

The load 4 may consume power that is generated by the power generation system 2, power that is stored in the battery system 20, or power that is supplied from the grid 3. An example of the load 4 may be an electric device at home or in a factory.

The energy storage system 1 may store power generated by the power generation system 2 in the battery system 20, or supply the generated power to the grid 3. The energy storage system 1 may supply power stored in the battery system 20 to the grid 3, or store power supplied from the grid 3 in the battery system 20. Additionally, the energy storage system 1 may supply power generated by the power generation system 2 or stored in the battery system 20 to the load 4. When the grid 3 is in an abnormal state, for example, when a power failure occurs, the energy storage system 1 may function as an uninterruptible power supply (UPS), and thus supply power generated by the power generation system 2 or stored in the battery system 20 to the load 4.

The energy storage system 1 may include a power conversion system (PCS) 10 for converting power, the battery system 20, a first switch 30, and a second switch 40.

The PCS 10 may convert power provided by the power generation system 2, the grid 3, or the battery system 20 into an appropriate form and supply the converted power to a location that needs the power. The PCS 10 may include a power conversion unit 11, a direct current (DC) link unit 12, an inverter 13, a converter 14, and an integrated controller 15.

The power conversion unit 11 may be a power conversion apparatus that is connected between the power generation system 2 and the DC link unit 12. The power conversion unit 11 may convert power, which is generated by the power generation system 12, into a DC link voltage and transmit the converted power to the DC link unit 12.

The power conversion unit 11 may include a power conversion circuit, such as a converter circuit or a rectifier circuit, based on the type of the power generation system 2. When the power generation system 2 generates DC power, the power conversion unit 11 may include a DC-DC converter circuit for converting DC power generated by the power generation system 2 into a different type of DC power. When the power generation system 2 generates alternating current (AC) power, the power conversion unit 11 may include a rectifier circuit for converting AC power into DC power.

When the power generation system 2 is a solar photovoltaic power generation system, the power conversion unit 11 may include a maximum power point tracking (MPPT) converter for performing MPPT controlling so as to maximize power generated by the power generation system 2 according to variations such as solar insolation or temperature. Additionally, when the power generation system 2 does not generate power, operation of the power conversion unit 11 may be discontinued to minimize power consumed by a converter or the like.

Due to problems such as an instantaneous voltage drop in the power generation system 2 or the grid 3, or the occurrence of a peak in the load 4, the level of the DC link voltage may be unstable. However, normal operation of the converter 14 and the inverter 13 requires that the DC link voltage remain stable. The DC link unit 12 may be connected between the power conversion unit 11 and the inverter 13 to substantially uniformly maintain the DC link voltage. An example of the DC link unit 12 may be a high-capacity capacitor.

The inverter 13 may be a power conversion apparatus that is connected between the DC link unit 12 and a first switch 30. The inverter 13 may include an inverter for converting the DC link voltage output from at least one of the power generation system 2 and the battery system 20 into an AC voltage of the grid 3 and outputting the AC voltage. Additionally, in order to store power from the grid 3 in the battery system 20 in a charge mode, the inverter 13 may include a rectifier circuit for converting the AC voltage from the grid 3 into a DC voltage and outputting a DC link voltage. The inverter 13 may be a bi-directional inverter in which the input and output directions may be changed.

The inverter 13 may include a filter for removing harmonic waves from the AC voltage that is output to the grid 3. Additionally, the inverter 13 may include a phase locked loop (PLL) circuit for synchronizing the phase of the AC voltage output from the inverter 13 with the phase of the AC voltage of the grid 3, in order to substantially prevent or restrict the generation of reactive power. Additionally, the inverter 13 may perform additional functions such as regulation of a voltage conversion range, power-factor improvement, removal of DC components, or protection or reduction of transient phenomena.

The converter 14 may be a power conversion apparatus that is connected between the DC link unit 12 and the battery system 20. The converter 14 may include a DC-DC converter for converting DC power stored in the battery system 20 into a DC link voltage at an appropriate voltage level in a discharge mode and outputting the converted power to the inverter 13. Additionally, the converter 14 includes a DC-DC converter for converting DC power output from the power conversion unit 11 or the inverter 13 into an appropriate DC voltage level, that is, the voltage level required by the battery system 20 and outputting the converted voltage to the battery system 20 in a charge mode. The converter 14 may be a bi-directional converter in which the input and output directions may be changed. When a charge or discharge operation of the battery system 20 is not performed, the operation of the converter 14 may cease, and thus, power consumption may be minimized or reduced.

The integrated controller 15 may monitor (or measure) the status of the power generation system 2, the grid 3, the battery 20, and the load 4. For example, the integrated controller 15 may monitor whether a power failure has occurred in the grid 3, whether power is generated by the power generation system 2, the amount of power generated by the power generation system 2, the charge status of the battery system 20, the amount of power consumed by the load 4, time, and so on.

The integrated controller 15 may control operations of the power conversion unit 11, the inverter 13, the converter 14, the battery system 20, the first switch 30, and the second switch 40 according to measured data and a predetermined algorithm. For example, when a power failure occurs in the grid 3, the integrated controller 15 may control power stored is the battery system 20 or generated by the power generation system 2 to be supplied to the load 4. Additionally, when sufficient power cannot be supplied to the load 4, the integrated controller 15 may determine the priority for electric apparatuses in the load 4 and control the load 4 to supply power to the high priority electric apparatuses. Additionally, the integrated controller 15 may control charge and discharge operations of the battery system 20.

The first and second switches 30 and 40 are connected in series between the inverter 13 and the grid 3 and are turned on/off based on the control of the integrated controller 15. The flow of power between the power generation system 2 and the grid 3 is controlled based on the open or closed states of the first and second switches 30 and 40. On/off statuses of the first and second switches 30 and 40 may be set according to statuses of the power generation system 2, the grid 3, and the battery system 20.

When power is supplied by at least one of the power generation system 2 and the battery system 20 to the load 4 or power is supplied by the grid 3 to the battery system 20, the first switch 30 is switched on. When power is supplied by at least one of the power generation system 2 and the battery system 20 to the grid 3 or power is supplied by the grid 3 to at least one of the load 4 and the battery system 20, the second switch 40 is switched on.

When a power failure occurs in the grid 3, the second switch 40 is switched off and the first switch 30 is switched on. In other words, power is supplied by at least one of the power generation system 2 and the battery system 20 to the load 4 and, at the same time, the power supplied to the load 4 is prevented from flowing into the grid 3. As such, by operating the energy storage system 1 as a stand-alone system disconnected from the grid 3, accidents such as electrocution of a worker working on a power line at the grid 3 or the like due to power supplied from the power generation system 2 or the battery system 20 may be prevented.

The first and second switches 30 and 40 may include a switching apparatus such as a relay, which may tolerate a high current.

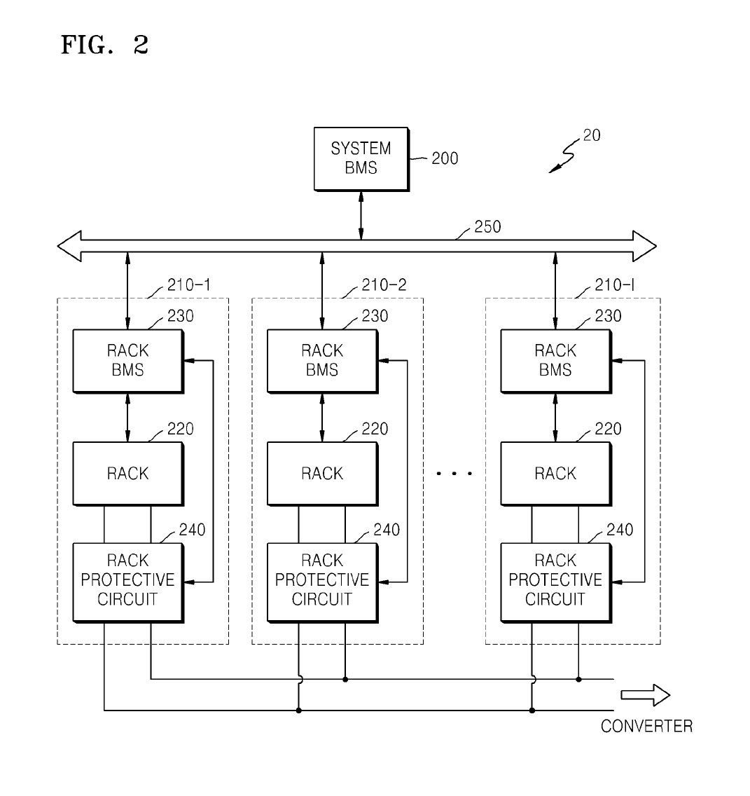

The battery system 20 may receive and store power from at least one of the power generation system 2 and the grid 3 and supply the stored power to at least one of the load 4 and the grid 3. The battery system 20 may include a component for storing power and another component for controlling and protecting the stored power. Charge and discharge operations of the battery system 20 may be controlled by the integrated controller 15. Hereinafter, referring to FIG. 2, the battery system 20 is described in detail.

FIG. 2 is a block diagram of the battery system 20 according to an embodiment.

Referring to FIG. 2, the battery system 20 may include a system battery management system (BMS) 200, a plurality of battery racks 210-1 through 210-1, and a first bus line 250 for data communication.

The battery racks 210-1 through 210-1 may store power supplied from an external source, that is, the power generation system 2 and/or the grid 3, and supply the stored power to the grid 3 and/or the load 4. The battery racks 210-1 through 210-1 may respectively include a rack 220, a rack BMS 230, and a rack protective circuit 240.

The rack 220 stores power. The rack 220 may include at least one or more trays 222, as shown in FIG. 3, which are connected to each other in series, in parallel, or in a combination of thereof. Charge and discharge operations of the rack 220 may be controlled by using the rack BMS 230. Respective racks 220 may be connected in series or parallel according to a required output voltage. FIG. 2 shows that the racks in the battery racks 210-1 to 210-1 are connected to each other in parallel. However, according to the requirements of the battery system 20, the battery racks 210-1 to 210-1 may be connected to each other in parallel or in a combination of series and parallel.

The rack BMS 230 may control all operations of the corresponding battery racks 210-1 to 210-1. The rack BMS 230 may control charge and discharge operations of the rack 220 by controlling the rack protective circuit 240. For example, when an overcurrent flows into the rack 220 or the rack 220 is over-discharged, the rack BMS 230 may prevent the transmission of power between the rack 220 and an input/output terminal, by opening a switch in the rack protective circuit 240. The rack BMS 230 may monitor the status of the rack 220, for example, the temperature, voltage, or current, and transmit the measured data to the system BMS 200. Additionally, the rack BMS 230 may control a cell balancing operation of battery cells, which are included in the rack 220, according to the measured data and a predetermined algorithm.

The rack protective circuit 240 may turn a switch on or disconnect power transmission, according to the control of the rack BMS 230. Additionally, the rack protective circuit 240 may provide an output voltage, an output current, and statuses of a switch and a fuse to the rack BMS 230.

Power that is output from the rack 220 may be supplied to the converter 14, shown in FIG. 1, via the rack protective circuit 240 and the power that is supplied from the converter 14 may be stored in the rack 220 via the rack protective circuit 240. Power lines, which extend from the rack protective circuits 240, may be connected to the converter 14 in parallel to each other. However, the described technology is not limited thereto, and the power lines may be connected in a series or in a combination of series and parallel, according to the power output requirements of the rack 220, or the voltage level that output from the rack 220.

The rack BMS 230 may collect data from the rack 220 and the rack protective circuit 240. Data collected from the rack protective circuit 240 may include the value of an output current, the value of an output voltage, the status of a switch, or the status of a fuse. Data, collected from the rack 220, may include the battery cell voltage or the temperature.

The rack BMS 230 may calculate the amount of remaining power, the lifecycle, or the state of charge (SOC) from the collected data, or determine whether an abnormality has occurred in the rack 220. For example, the rack BMS 230 may determine whether an abnormality such as overcharge, overdischarge, overcurrent, overvoltage, overheat, battery cell imbalancing, or deterioration of a battery cell has occurred. When an abnormality has occurred, the rack BMS 230 may perform an operation that is determined according to an internal algorithm. For example, the rack BMS 230 may engage the rack protective circuit 240.

The first bus line 250 is a path for transmitting data or commands between the system BMS 200 and the rack BMSs 230. Controller area network (CAN) communication may be used as a communication protocol between the system BMS 200 and the rack BMSs 230. However, the communication protocol is not limited thereto, and any communication protocol that transmits data or commands may be used.

The rack BMSs 230 may provide data collected from the rack 220 and the rack protective circuit 240 to the system BMS 200 via the first bus line 250. The rack BMSs 230 may provide information about whether an abnormality has occurred and the type of the abnormality to the system BMS 200. In this case, the system BMS 200 may control the rack BMSs 230. For example, the system BMS 200 may transmit a control command to the rack BMS 230 so that the rack protective circuit 240 in the battery racks 210-1 through 210-1 may be engaged.

The system BMS 200 may transmit data collected from the rack BMSs 230 to the integrated controller 15 that is shown in FIG. 1. The system BMS 200 may provide information about whether an abnormality has occurred in the battery racks 210-1 through 210-1 and the type of the abnormality to the integrated controller 15. Additionally, the integrated controller 15 may provide information about the status of the PCS 10, for example, the status of the converter 14, to the system BMS 200. For example, the integrated controller 15 may provide information about opening of the converter 14 or the input/output terminal or the flow of current to the converter 14 to the system BMS 200. The system BMS 200 may control the operation of the battery system 20 based on information received from the integrated controller 15. For example, the system BMS 200 may transmit a control command to the rack BMSs 230 so that the battery racks 210-1 through 210-1 are turned on according to the status of the PCS 10.

Hereinafter, a detailed description of the first battery rack 210-1 is provided.

FIG. 3 is a block diagram of the battery rack 210-1 according to an embodiment.

Referring to FIG. 3, the battery rack 210-1 may include a plurality of battery trays 221-1 through 221-m, the rack BMS 230, and a second bus line 224 for data communication. The battery rack 210-1 may include the rack protective circuit 240. However, the rack protective circuit 240 is not illustrated in FIG. 3.

The battery trays 221-1 through 221-m are subcomponents of the rack. The battery trays 221-1 through 221-m store power supplied from the grid 3 and/or the power generation system 2 and transmit the stored power to the grid 3 and/or the load 4. The battery trays 221-1 through 221-m may respectively include a tray 222 and a tray BMS 223.

The tray 222 stores power and may include at least one or more battery cells that are connected to each other in series, in parallel, or in a combination thereof. The number of battery cells included in the tray 222 may be set according to the required output voltage. The battery cell may include a rechargeable secondary battery. For example, the battery cell may include a nickel-cadmium battery, a nickel metal hydride (NiMH) battery, a lithium ion battery, or a lithium polymer battery.

Charge and discharge operations of the tray 222 may be controlled by the tray BMS 223. A plurality of the trays 222 are connected to each other in series, and thus, generate an output voltage that is required by the rack 220. Additionally, a power line extends from the trays 222 at both ends connecting each of the trays 22 in series, and thus, may supply power to the converter 14, shown in FIG. 1, via the rack protective circuit 240.

The tray BMS 223 may control charge and discharge operations of the tray 222. Additionally, the tray BMS 223 may monitor the status of the tray 222, for example, the temperature, voltage, or current flow, and transmit the measured data to the rack BMS 230.

The second bus line 224 is a path for transmitting data or a commands between the rack BMS 230 and the tray BMSs 223. CAN communication may be used as a communication protocol between the rack BMS 230 and the tray BMSs 223. However, the communication protocol is not limited thereto and any communication protocol that transmits data or commands may be used.

According to some embodiments, both the communication protocol between the system BMS 200 and the rack BMS 230 and the communication protocol between the rack BMS 230 and the tray BMS 223 employs a bus line. However, this is only an example and the described technology is not limited thereto. According to other embodiments, at least one of the communication protocols employs a bus line for communication.

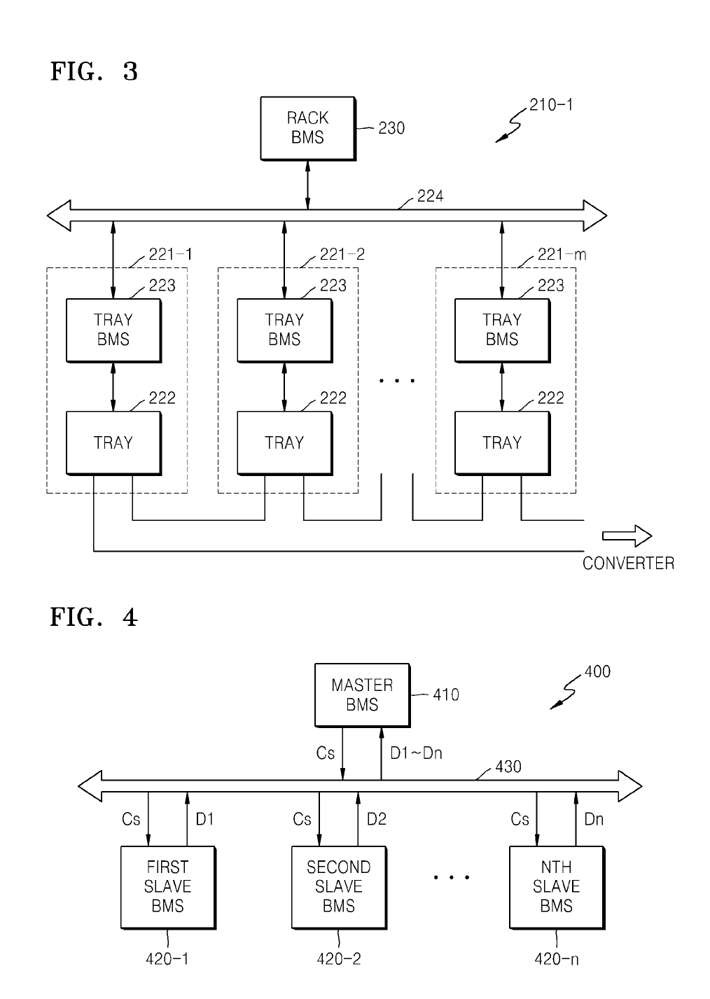

FIG. 4 is a block diagram of a communication system 400 having a master-slave structure.

Referring to FIG. 4, the communication system 400 includes a master BMS 410, a plurality of slave BMSs 420-1 through 420-n, and a fourth bus line 430.

The master BMS 410 may transmit a frame signal Cs, which includes a command, to the fourth bus line 430. The first through nth slave BMSs 420-1 through 420-n may receive the frame signal Cs and perform an operation corresponding to the command included in the frame signal Cs. The frame signal Cs may include an ID assignment command and may be transmitted to all of the slave BMSs 420-1 through 420-n in a broadcast method. The frame signal Cs may include a command for controlling the slave BMSs 420-1 through 420-n and may be transmitted to a specific slave BMS from among the slave BMSs 420-1 through 420-n.

Additionally, each of the slave BMSs 420-1 through 420-n may transmit frame signals D1 through Dn including data to the fourth bus line 430. The first through nth slave BMSs 420-1 through 420-n may transmit the frame signals D1 through Dn including the ID of the corresponding slave BMS to the master BMS 410, so as to prevent the data from colliding. The master BMS 410 may receive the transmitted frame signals D1 through Dn in order to perform predetermined processing based on the received frame signals D1 through Dn.

The frame signals D1 through Dn may be transmitted to the slave BMSs 420-1 to 420-n as well as to the master BMS 410. For example, the frame signal D1, which is transmitted by the first slave BMS 420-1, may be transmitted to the remaining slave BMSs 420-2 through 420-n in a broadcast method. The frame signals D1 through Dn may include data that represents a cumulative value of driving time and an ID assignment completion signal.

The master BMS 410 may correspond to the system BMS 200, shown in FIG. 2, and the first through nth slave BMSs 420-1 through 420-n may correspond to the rack BMS 230, shown in FIG. 2. Additionally, the master BMS 410 may correspond to the rack BMS 230, shown in FIG. 3, and the first through nth slave BMSs 420-1 through 420-n may correspond to the tray BMS 223, shown in FIG. 3.

Hereinafter, a method of transmitting data performed by the communication system 400 having such a master-slave structure is described.

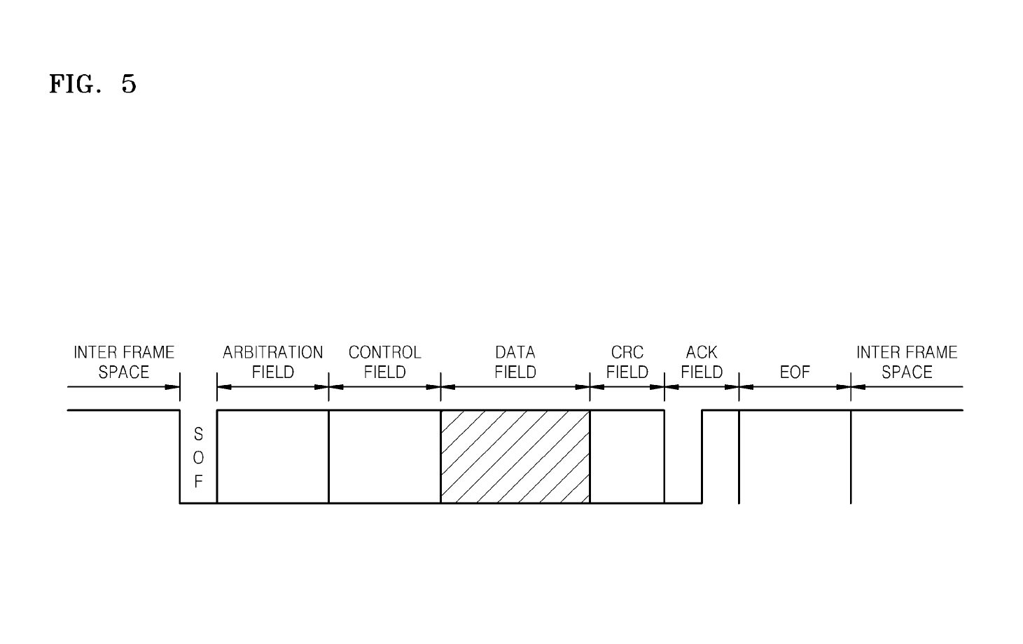

FIG. 5 is a diagram illustrating the frame structure of the CAN communication protocol. CAN is a communication protocol developed by Bosch so as to be applied to an automobile industry. Recently, CAN is being applied to various industries in addition to the automobile industry. CAN is a serial network communication method using a multi-master message method at a defined rate and is provided in ISO 11898 specification.

Referring to FIG. 5, the start of a message frame is indicated by a “start of frame (SOF)”. The “SOF” is located at the beginning of the message frame and has a value of “0” which is a dominant bit as set by default.

An “arbitration field” has an ID and a remote transmission request (RTR) bit. The RTR bit indicates whether the message frame is a data frame or a remote frame. When the current message frame is a data frame for transmitting data, the RTR bit has a value of “0”. Alternatively, when the current message frame is a remote frame requesting data transmission, the RTR bit has a value of “1”, which is a recessive bit.

A “control field” is formed of six bits. Two of the bits are for a reserved area and the remaining four bits are for a data length code area indicating the number of bytes of a “data field”.

A “data field” includes data to be transmitted from the data frame. The size of the “data field” is from 0 to 8 bytes and each byte includes 8 bits. Each byte of data is transmitted from a most significant bit (MSB) with a value of 0.

A “cyclic redundancy code (CRC) Field” indicates a CRC. The “CRC field” includes “CRC Sequence” and “CRC Delimiter” having a value of “1”.

An “acknowledge (ACK) field” is formed of 2 bits and includes an ‘ACK slot’ and an ‘ACK delimiter’. The ‘ACK slot’ constituting a first bit has a value of “0”, and the ‘ACK delimiter’ constituting a second bit has a value of “1”. However, an ‘ACK slot’ may be recorded as a value of “1” which is transmitted from another node that successfully received a message.

An “end of frame (EOF)” is formed of 7 bits all having a value of “1”, and indicates that the message frame has ended.

An “interframe space” includes ‘intermission’ and ‘bus Idle’ and distinguishes a previous or next message frame from a current message frame.

Hereinafter, with regard to a battery system 600 including a master BMS 610 and a plurality of slave BMSs 620-1 through 620-n, a method performed by the slave BMSs 620-1 through 620-n including setting and displaying IDs of the slave BMSs 620-1 through 620-n will be described.

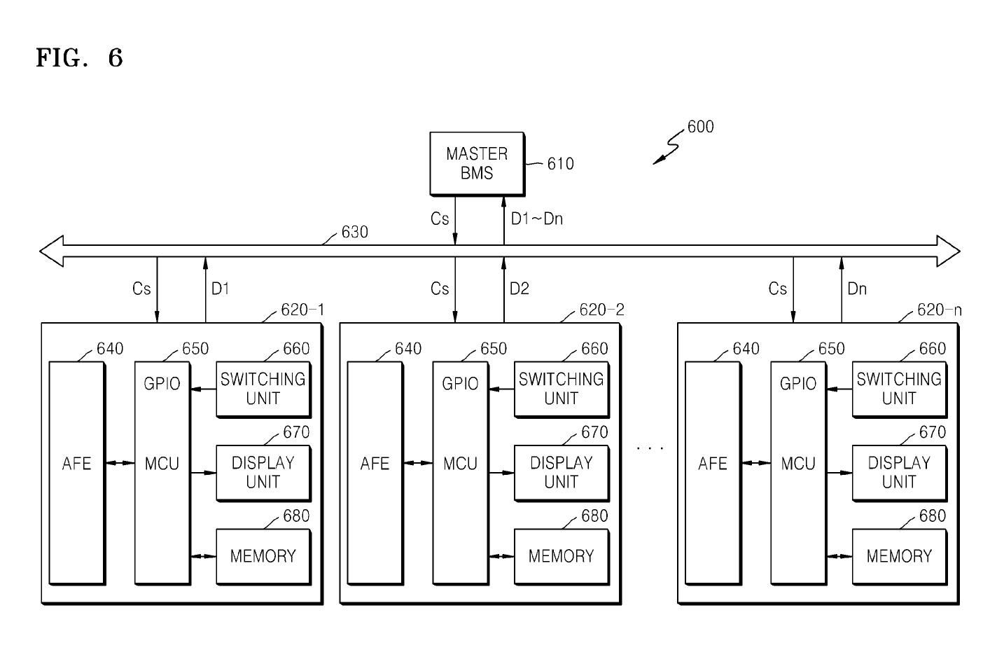

FIG. 6 is a block diagram of a battery system having a master-slave structure for setting and displaying an ID.

Referring to FIG. 6, the battery system 600 includes the master BMS 610 and the slave BMSs 620-1 through 620-n. For better understanding of the present embodiment, FIG. 6 shows that the master BMS 610 and the slave BMSs 620-1 through 620-n execute CAN communication via the sixth bus line 630. However, the described technology is not limited to being applied to a CAN communication method and may be applied to different communication methods using the same principle.

In the current embodiment, the slave BMSs 620-1 through 620-n respectively include an analog front end (AFE) 640, a micro-control unit (MCU) (or controller) 650, a switching unit (or switch) 660, a display unit (or display) 670, and a memory 680.

The AFE 640 measures data regarding the voltage, current, temperature, remaining amount of power, lifecycle, and/or state of charge of the tray 222, shown in FIG. 3, which includes at least one battery cell. While the AFE 640 is measuring the data, the master BMS 610 may measure the charge/discharge current of the tray 222.

The MCU 650 transmits the measured data, which is measured by the AFE 640, to the master BMS 610 via the sixth bus line 630. In the current embodiment, the MCU 650 controls the setting and displaying of the ID of the slave BMSs and communicates with the master BMS 610 via the sixth bus line 630 by using the set ID. The MCU 650 determines an operation mode by measuring the pulse width of a pulse signal that is transmitted by the switching unit 660 and determines the IDs of the slave BMSs 620-1 through 620-n by measuring the number of generated the pulse signals. The MCU 650 also controls the IDs of the slave BMSs 620-1 through 620-n to be displayed on the display unit 670. Hereinafter, a detailed description of each of the MCU 650, the switching unit 660 and the display unit 670 is provided.

The switching unit 660 my include a button switch and may generate a pulse signal according to an input to the button switch. For example, when the button switch is pushed, a pulse signal is generated including a pulse width that corresponds to the period the button is pushed. However, the switching unit 660 is not limited thereto and any switching unit 660 that may generate a pulse signal may be used. While the switching unit 660 is maintained in an input state (i.e. a pushed state for a button switch), a low signal is input to the MCU 650. When the switching unit 660 is maintained in a non-input state (i.e. a non-pushed state for a button switch), a high signal is input to the MCU 650.

In some embodiments, the switching unit 660 is connected to a general-purpose input/output (GPIO) port of the MCU 650, and thus, the MCU 650 may detect a pulse signal from the switching unit 660 via the GPIO port. The GPIO port is a general-use port that may be controlled or programmed by a user. Thus, in these cases, a signal generated by the user may be input to the GPIO port.

In the current embodiment, the MCU 650 operates the slave BMSs 620-1 through 620-n in three modes by monitoring the pulse signal that is generated from the switching unit 660. The first mode is a reset mode in which the MCU 650 measures the input period for an input to the switching unit 660 and when a low pulse input signal received from the switching unit 660 is maintained for a predetermined first period or less, for example, for 5 seconds or less, the slave BMSs 620-1 through 620-n are software-reset. The MCU 650 may measure the time for the input from the switching unit 660 by starting a timer in response to a falling edge of the pulse signal and stopping the timer in response to a rising edge of the pulse signal. The second mode is an ID setting mode in which the MCU 650 measured the input period for the input received from the switching unit 660 and when a low pulse input signal received from the switching unit 660 is maintained for the predetermined first period or longer, for example, for longer than 5 seconds, the IDs of the slave BMSs 620-1 through 620-n are set. The third mode is a battery charge/discharge mode in which, after the ID setting is completed in the ID setting mode, the MCU 650 measured the input period for the input received from the switching unit 660 and when a low pulse input signal received from the switching unit 660 is maintained for the predetermined first period or longer, for example, for longer than 5 seconds, the ID setting mode is deactivated.

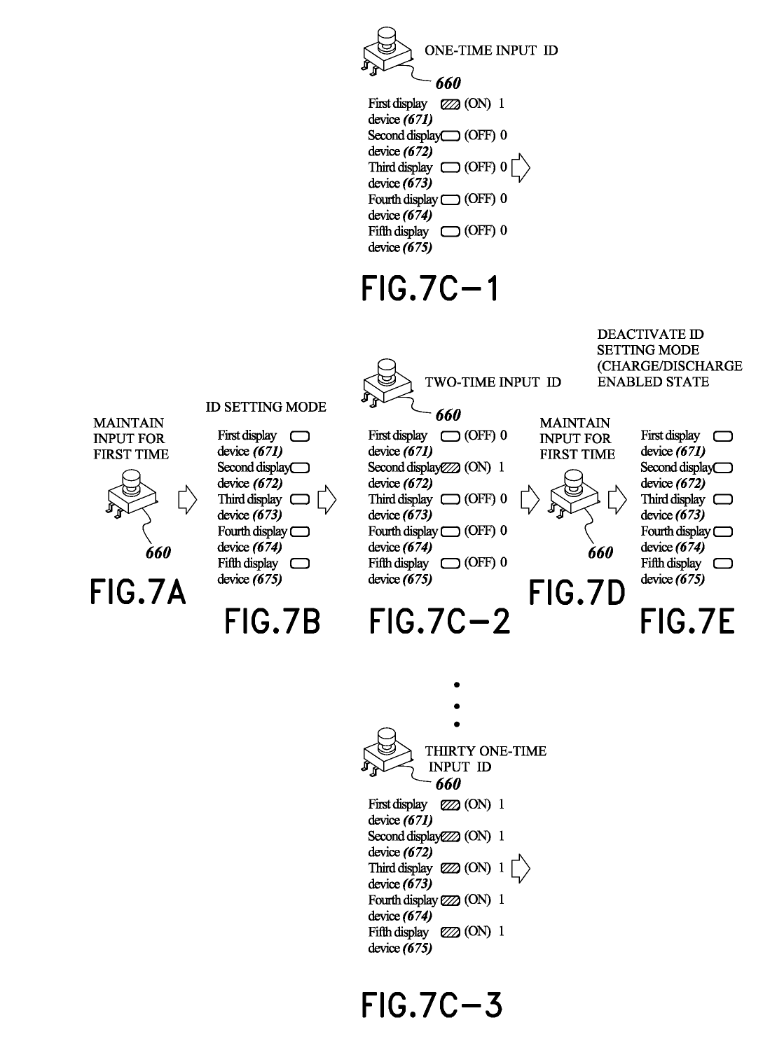

The display unit 670 displays the status of the tray in the ID setting mode. The display unit 670 may include a plurality of display devices, for example, a first display device 671 through a fifth display device 675. The display devices are not limited to a first through fifth display device 671 through 675 as shown in FIGS. 7A through 7E and may include more display devices than shown in FIGS. 7A through 7E. Additionally, the first through fifth display devices 671 through 675 may be, for example, LED devices. The first through fifth display devices 671 through 675 are not limited to LED devices and any device that may display information may be used. The status of the tray, which is displayed by the display unit 670 in the ID setting mode, represents the status in which the IDs of the slave BMSs 620-1 through 620-n are expressed as binary numbers by turning on or off the first through fifth display devices 671 through 675. However, in a reset mode or a battery charge/discharge mode, the display unit 670 may display a charge status, a discharge status, a high voltage status, a low voltage status, a high temperature status, or a low temperature status by using the first display device 671 through the fifth display device 675.

The memory 680 stores the ID as a binary number.

Hereinafter, referring to FIGS. 7A through 7E, the process of setting and displaying the IDs of the slave BMSs 620-1 through 620-n by using the MCU 650, the switching unit 660, and the display unit 670 will be described.

FIG. 7A is a diagram illustrating a process in which the MCU 650 measures the time period for an input from the switching unit 660 and when a low pulse input signal received from the switching unit 660 is maintained for a predetermined first period or longer, for example, for 5 seconds or longer, the slave BMSs 620-1 through 620-n are entered into the ID setting mode.

FIG. 7B is a diagram illustrating the status of the first through fifth display devices 671 through 675 that are included in the display unit 670, after the slave BMSs 620-1 through 620-n are entered into the ID setting mode. It may be understood that the first through fifth display devices 671 through 675 are in a standby mode so as to display the set IDs.

FIGS. 7C-1 through 7C-3 are diagrams in which the MCU 650 determines the IDs of the slave BMSs 620-1 through 620-n by measuring the number of generated pulse signals from the switching unit 660 and controlling the IDs of the slave BMSs 620-1 through 620-n to be displayed on the display unit 670.

FIG. 7C-1 is a diagram in which the MCU 650 detects the generation of a single pulse signal according to an input from the switching unit 660 and only the first display device 671, from among the first through fifth display devices 671 through 675, is turned on. In this case, the MCU 650 sets the IDs of the slave BMSs 620-1 through 620-n as a binary number “10000” and stores the IDs in the memory 680. The first through fifth display devices 671 through 675 may blink for a predetermined period of time, for example, for 1 second when their IDs are set.

FIG. 7C-2 is a diagram in which the MCU 650 detects the generation of two pulse signals according to an input from the switching unit 660 and only the second display device 672, from among the first through fifth display devices 671 through 675, is turned on. In this case, the MCU 650 sets the IDs of the slave BMSs 620-1 through 620-n as a binary number “01000” and stores the IDs in the memory 680. The first through fifth display devices 671 through 675 may blink for a predetermined period of time, for example, for 1 second when their IDs are set.

FIG. 7C-3 is a diagram in which the MCU 650 detects the generation of thirty one pulse signals according to an input from the switching unit 660 and each of the first through fifth display devices 671 through 675 are turned on. In this case, the MCU 650 sets the IDs of the slave BMSs 620-1 through 620-n as a binary number “11111” and stores the IDs in the memory 680. The first through fifth display devices 671 through 675 may blink for a predetermined period of time, for example, for 1 second when their IDs are set.

FIG. 7D is a diagram in which, after the ID setting of the slave BMSs 620-1 through 620-n is finished, the MCU 650 measures the time period for an input from the switching unit 660 and when a low pulse input signal received from the switching unit 660 is maintained at a first period or longer, for example, for 5 seconds or longer, the MCU 650 exits the slave BMSs 620-1 through 620-n from the ID setting mode and enters the slave BMSs 620-1 through 620-n to a battery charge/discharge mode.

FIG. 7E is a diagram illustrating the status of the first through fifth display devices 671 through 675 that are included in the display unit 670, after the slave BMSs 620-1 through 620-n are entered in the battery charge/discharge mode. The first through fifth display devices 671 through 675 may display a charge status, a discharge status, a high voltage status, a low voltage status, a high temperature status, or a low temperature status of a battery.

As such, the IDs are set by turning the first through fifth display devices 167 through 675 on according to the number of generated pulse signals from the switching unit 660. Thus, it may not be necessary to further provide an additional circuit for detecting a physical connection order or manage hardware or software respectively for each slave BMS, in order to set an ID.

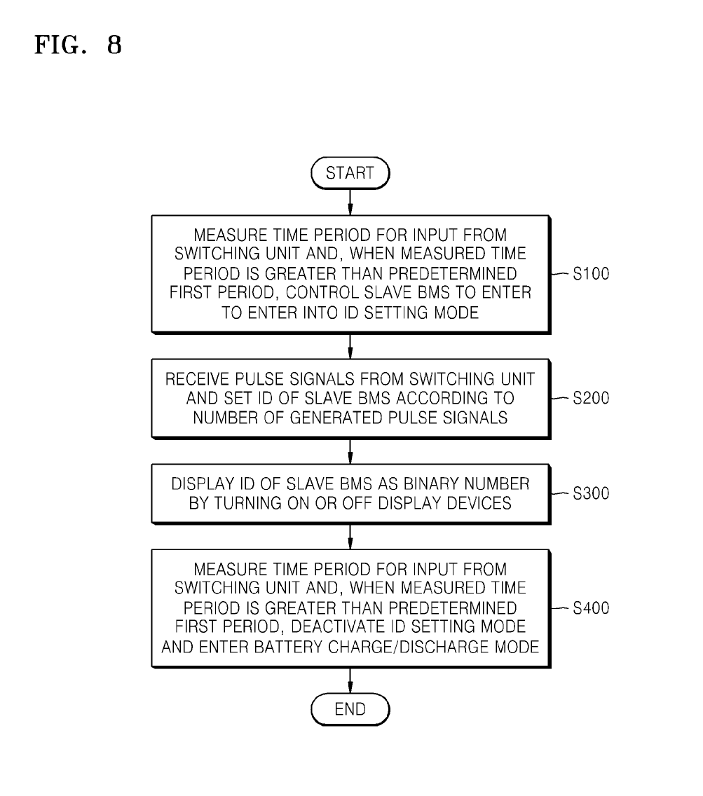

FIG. 8 is a flowchart illustrating a method of controlling a battery system having a master-slave structure for setting and displaying an ID. According to the embodiment illustrated in FIG. 6, the method of controlling the battery system is performed by using peripheral components that include the switching unit 660 and the display unit 670. In the description provided below, descriptions of components and processes similar to those of FIGS. 1 through 7 will not provided again.

In some embodiments, the FIG. 8 procedure is implemented in a conventional programming language, such as C or C++ or another suitable programming language. The program can be stored on a computer accessible storage medium of the slave BMSs 620, for example, the memory 680. In certain embodiments, the storage medium includes a random access memory (RAM), hard disks, floppy disks, digital video devices, compact discs, video discs, and/or other optical storage mediums, etc. The program may be stored in a processor. The processor can have a configuration based on, for example, i) an advanced RISC machine (ARM) microcontroller and ii) Intel Corporation's microprocessors (e.g., the Pentium family microprocessors). In certain embodiments, the processor is implemented with a variety of computer platforms using a single chip or multichip microprocessors, digital signal processors, embedded microprocessors, microcontrollers, etc. In another embodiment, the processor is implemented with a wide range of operating systems such as Unix, Linux, Microsoft DOS, Microsoft Windows 7/Vista/2000/9x/ME/XP, Macintosh OS, OS/2, Android, iOS and the like. In another embodiment, at least part of the procedure can be implemented with embedded software. Depending on the embodiment, additional states may be added, others removed, or the order of the states changed in FIG. 8.

Referring to FIG. 8, in step S100, the MCU 650 measures the time period for an input from the switching unit 660 that generates a pulse signal according to the input and, when the measured time period from the switching unit 660 is greater than a predetermined first period, for example, about 5 seconds or more, enters the slave BMSs 620-1 through 620-n into an ID setting mode. After the slaves BMSs 620-1 through 620-n enter the ID setting mode, the first through fifth display devices 671 through 675 are in a standby mode so as to display the set IDs.

When the slave BMSs 620-1 through 620-n enter the ID setting mode, in step S200, the MCU 650 receives pulse signals from the switching unit 660 and sets the IDs of the slave BMSs 620-1 through 620-n according to the number of generated pulse signals. In addition to the setting of the IDs of the slave BMSs 620-1 through 620-n, in step S300, the MCU 650 displays the IDs of the slave BMSs 620-1 through 620-n as a binary number by turning the first through fifth display devices 671 through 675 on or off.

When the MCU 650 detects the generation of a single pulse signal according to the input from the switching unit 660, only the first display device 671, from among the first through fifth display devices 671 through 675 is turned on. In this case, the MCU 650 sets the IDs of the slave BMSs 620-1 through 620-n as a binary number “10000” and stores the IDs in the memory 680.

When the MCU 650 detects the generation of two pulse signals according to the input from the switching unit 660, only the second display device 672, from among the through fifth display devices 671 through 675 is turned on. In this case, the MCU 650 sets the IDs of the slave BMSs 620-1 through 620-n as a binary number “01000” and stores the IDs in the memory 680.

When the MCU 650 detects the generation of thirty one pulse signals according to the input from the switching unit 660 all of the first through fifth display devices 671 through 675 are turned on. In this case, the MCU 650 sets the IDs of the slave BMSs 620-1 through 620-n as a binary number “11111”, and stores the IDs in the memory 680. The first through fifth display devices 671 through 675 may blink for a predetermined period of time, for example, for about 1 second when their IDs are set.

After the ID setting and displaying are completed, in step S400, the MCU 650 measures the time period for an input from the switching unit 660 and, when measured time period from the switching unit 660 is greater than a predetermined first period or more, for example, about 5 seconds or more, the ID setting mode is deactivated, and enters the slave BMSs 620-1 through 620-n into the battery charge/discharge mode. When the slave BMSs 620-1 through 620-n enter the battery charge/discharge mode, the first through fifth display devices 671 through 675 may display a charge state, a discharge state, a high voltage state, a low voltage state, a high temperature state, or a low temperature state of a battery.

As described above, according to at least one embodiment, the IDs may be set by using a switch for software-resetting the slave BMS and a display unit including a plurality of display devices. Thus, with regard to the slave BMS, it may not be necessary to provide an additional circuit for detecting a physical connection order or manage hardware or software respectively for each slave BMS, in order to set an ID that matches a physical connection order.

Accordingly, the slave BMSs may be easily replaceable and interchangeable without any restriction and an increase in manufacturing costs for an additional circuit may be prevented, and similarly, additional management may not be required.

The described embodiments are not intended to limit the scope of the described technology in any way. For the sake of brevity, conventional electronics, control systems, software development and other functional aspects of the systems (and components of the individual operating components of the systems) may not be described in detail. Furthermore, the connecting lines, or connectors shown in the various figures presented are intended to represent exemplary functional relationships and/or physical or logical couplings between the various elements. It should be noted that many alternative or additional functional relationships, physical connections, or logical connections may be present in a practical device. Moreover, no item or component is essential to the practice of the described technology unless the element is specifically described as “essential” or “critical”.

The use of the terms “a” and “an” and “the” and similar referents in the context of describing the described technology (especially in the context of the following claims) are to be construed to cover both the singular and the plural. Furthermore, the recitation of ranges of values herein are merely intended to function as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The use of any and all examples, or exemplary language (e.g., “such as”) provided herein, is intended merely to better illuminate the described technology and does not pose a limitation on the scope of the described technology unless otherwise claimed. Additionally, it will be understood by those of ordinary skill in the art that various modifications, combinations, and changes can be formed according to design conditions and factors within the scope of the attached claims or the equivalents.

It should be understood that the exemplary embodiments described herein should be considered in a descriptive sense only and not for purposes of limitation. Descriptions of features or aspects within each embodiment should typically be considered as available for other similar features or aspects in other embodiments.

While one or more embodiments of the described technology have been described with reference to the figures, it will be understood by those of ordinary skill in the art that various changes in form and details may be made therein without departing from the spirit and scope of the present invention as defined by the following claims.

What is claimed is:

1. A battery system, comprising:
a plurality of battery trays each comprising at least one battery cell;
a plurality of slave battery management systems (BMSs) configured to respectively control the battery trays; and
a master BMS configured to control the slave BMSs,
wherein each of the slave BMSs comprises:
a switch configured to generate a pulse signal based at least in part on an input;
a display configured to display a status of the corresponding battery tray; and
a controller configured to: i) determine an operation mode of the slave BMS based at least in part on a pulse width of the pulse signal, ii) assign an identifier (ID) of the slave BMS based at least in part on the number of generated pulse signals, and iii) control the display to display the ID of the slave BMS.

2. The battery system of claim 1, wherein the controller is further configured to: i) determine an input period of the input to the switch based at least in part on the pulse width of the pulse signal and ii) start an ID setting mode when the input period is greater than a predetermined first period.

3. The battery system of claim 2, wherein the controller is further configured to start a reset mode when the input period is less than the predetermined first period.

4. The battery system of claim 1, wherein the display comprises a plurality of display devices and wherein the display is further configure to display the ID of the slave BMS as a binary number by turning on or off the display devices.

5. The battery system of claim 2, wherein the display is further configured to display information indicating that the slave BMS is operating in the ID setting mode.

6. The battery system of claim 2, wherein the controller is further configured to end the ID setting mode and start a battery charge/discharge mode when the input period is greater than the predetermined first period.

7. The battery system of claim 6, wherein the display is further configured to display the status of the battery tray when the slave BMS is in the charge/discharge mode and wherein the status comprises at least one of a charge/discharge status, a voltage status, or a temperature status.

8. The battery system of claim 1, wherein the master BMS and the slave BMS are configured to communicate data according to a controller area network (CAN) communication protocol.

9. A method of controlling a battery system that comprises a plurality of slave BMSs each including a switch, the method comprising:
generating a pulse signal based at least in part on an input to the switch;
receiving the pulse signal from the switch;
determining an operation mode based at least in part on a pulse width of the pulse signal;
assigning an identifier (ID) of the slave BMS according to the number of generated pulse signals; and
displaying the ID of the slave BMS.

10. The method of claim 9, wherein the determining comprises:
determining an input period of the input to the switch based at least in part on the pulse width of the pulse signal; and
starting an ID setting mode when the input period is greater than a predetermined first period.

11. The method of claim 10, wherein the determining further comprises:
starting a reset mode when the input period is less than the predetermined first period.

12. The method of claim 9, wherein each slave BMS further comprises a display including a plurality of display devices and wherein the displaying comprises displaying the ID of the slave BMS as a binary number by turning on or off the display devices.

13. The method of claim 10, wherein the displaying further comprises displaying information indicating that the slave BMS is operating in the ID setting mode.

14. The method of claim 10, further comprising ending the ID setting mode and starting a battery charge/discharge mode when the input period is greater than the predetermined first period.

15. The method of claim 14, wherein the battery system further comprises a plurality of battery trays and wherein each of the slave BMSs is configured to control a respective battery tray, the method further comprising displaying a status of the battery tray when the slave BMS is in the charge/discharge mode, wherein the status comprises at least one of a charge/discharge status, a voltage status, or a temperature status.

16. The method of claim 9, wherein the battery system further comprises a master BMS configured to control the slave BMSs and wherein the master BMS and the slave BMSs are configured to communicate data according to a controller area network (CAN) communication protocol.

17. A power storage system, comprising:
a battery system comprising: i) a plurality of slave BMSs configured to control a battery tray and ii) a master BMS configured to control the slave BMSs;
wherein the power storage system is connected to a power generation system, a grid, and a load,
wherein the power storage system is configured to supply power to the load from at least one of the battery system, the power generation system, or the grid, and
wherein each of the slave BMSs comprises:
a switch configured to generate a pulse signal based at least in part on an input;
a display configured to display a status of the battery tray; and
a controller configured to: i) determine an operation mode of the slave BMS based at least in part on a pulse width of the pulse signal, ii) assign an identifier (ID) of the slave BMS based at least in part on the number of generated pulse signals, and iii) control the display to display the ID of the slave BMS.

18. The power storage system of claim 17, wherein the controller is further configured to: i) determine an input period of the input to the switch based at least in part on the pulse width of the pulse signal and ii) start an ID setting mode when the input period is greater than a predetermined first period.

19. The power storage system of claim 18, wherein the controller is further configured to start a reset mode when the input period is less than the predetermined first period.

20. The power storage system of claim 18, wherein the controller is further configured to end the ID setting mode and start a battery charge/discharge mode when the input period is greater than the predetermined first period.
